(19) United States
(12) Patent Application Publication
(10) Pub. No.: US 2023/0226607 A1
(43) Pub. Date: Jul. 20, 2023

(54) Green Synthesis of Silver Nanoparticles using CMC Powder and Investigation of Its Antibacterial Activity

(71) Applicants: Hamed Ahari, Tehran (IR); Seyed Amirali Anvar, Tehran (IR); Maryam Ataee, Tehran (IR); Sima Moradi, Tehran (IR); Sogand Heydari, Tehran (IR); Hourieh Shalchi, Tehran (IR)

(72) Inventors: Hamed Ahari, Tehran (IR); Seyed Amirali Anvar, Tehran (IR); Maryam Ataee, Tehran (IR); Sima Moradi, Tehran (IR); Sogand Heydari, Tehran (IR); Hourieh Shalchi, Tehran (IR)

(21) Appl. No.: 17/410,112

(22) PCT Filed: Oct. 8, 2020
(86) PCT No.: PCT/IB2020/059441

§ 371 Date: Aug. 24, 2021

(51) Int. Cl. B22F 9/24; B22F 1/054; B82Y 40/00; B22F 9/10; B22F 1/142

(52) U.S. Cl. CPC B22F 9/24; B22F 1/054; B82Y 40/00; B22F 9/10; B22F 1/142; B22F 2009/0896

(57) ABSTRACT

The present invention is directed to a method to produce silver nanoparticles. The method includes the steps of dropwise addition of silver nitrate solution to a carboxymethyl cellulose solution (1%) while stirring. The solution is subjected to ultrasonic irradiation for 30 minutes. The first indication of silver nanoparticles being synthesized can be change in the color of the solution to yellowish-brown after Ultrasonication. The solution can thereafter be subjected to microwave irradiations. After the predetermined duration, the produced silver nanoparticles can be separated from the solution. The nanoparticles can be washed and freeze dried.

### FIELD OF INVENTION

The present invention relates to a method for production of nanoparticles, and more particularly, to methods for the synthesis of silver nanoparticles.

### BACKGROUND

Silver nanoparticles have gained much attention nowadays for chemical and biomedical applications. Antimicrobial coating of silver nanoparticles has been used for a range of household items including clothing.

Silver nanoparticles have been known to be produce from numerous chemical methods that uses toxic chemicals. Considering the increasing use of the silver nanoparticles in various fields including chemical and biomedical, a need is appreciated for a green method for producing silver nanoparticles.

### SUMMARY OF THE INVENTION

The principal object of the present invention is therefore directed to a method for producing silver nanoparticles that is environment friendly.

It is an object of the present invention that the method does not use toxic chemicals.

It is an additional object of the present invention that the method has improved atom economy.

It is another object of the present invention that the method is cost efficient.

It is a further object of the present invention that the method generates lesser waste.

In one aspect, disclosed is a method for production of silver nanoparticles. The silver nanoparticles can be produced by dropwise adding a silver nitrate solution to a carboxy methyl cellulose solution.

These and other objects and advantages of the embodiments herein will become readily apparent from the following detailed description.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a flow chart showing a method of production of the silver nanoparticles, according to an exemplary embodiment of the present invention.

FIG. 2 shows a UV-Vis Graph of the silver nanoparticles, according to an exemplary embodiment of the present invention.

FIG. 3 shows a representative transmission electron microscope (TEM) image of the silver nanoparticles, according to an exemplary embodiment of the present invention.

FIG. 4 shows a FTIR graph of silver nanoparticles, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as compositions or methods of treatment. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

Unless otherwise indicated, all numbers expressing quantities of ingredients used in this disclosure are to be understood as being modified in all instances by the term “about.” Accordingly, unless indicated to the contrary, the numerical parameters set forth in this disclosure are approximations that may vary depending upon the desired properties sought to be obtained by the present disclosure. At the very least, and not as an attempt to limit the application of the doctrine of equivalents to the scope of any claims, each numerical parameter should be construed in light of the number of significant digits and ordinary rounding approaches.

The present invention is directed to a method to produce silver nanoparticles. The method comprises adding silver nitrate solution to a carboxymethyl cellulose (CMC) solution, wherein the silver nitrate solution is added dropwise and slowly. While adding the silver nitrate solution, the CMC solution can be subjected to ultrasonic vibrations. Once the silver nitration solution is added to the CMC solution, the resultant solution can be further subjected to ultra-sonification for predetermined duration. Thereafter, the solution can be subjected to oven microwave irradiations to hasten the formation of nanoparticles. The produced nanoparticles can then be separated from the solution, for example, the resultant solution can be subjected to centrifugation to separate the nanoparticles from the solution. The separated nanoparticles can then be washed, for example the nanoparticles can be washed 3-4 times using acetone. The resultant silver nanoparticles can then be analyzed using microscopic methods, such as UV Visible spectroscopy, TEM microscopy, and FTIR spectroscopy.

In one embodiment, the produced silver nanoparticles can be evaluated using spectrophotometric methods and like. The produced silver nanoparticles can be of a size ranging from 30-40 nm. The nanoparticles produced by the method disclosed herein shows no signs of agglomeration. As evaluated by the TEM microscopy, the produced nanoparticles show no signs of agglomeration. FTIR peaks analysis resulted in the existence of CMC biomolecules in silver nanoparticles. The silver nanoparticles produced according to the present invention show good antimicrobial activity.

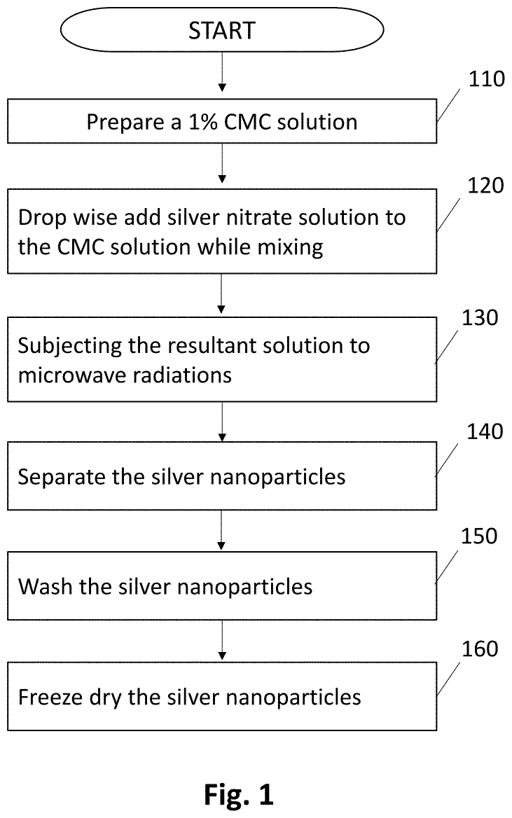

Referring to FIG. 1 which shows an exemplary embodiment to produce silver nanoparticles. At step 110, a 1% CMC solution can be prepared from CMC powder in water. To the CMC solution can be dropwise added silver nitrate solution while stirring the mixture, at step 120. The solution is subjected ultrasonic irradiation for 30 minutes. The first indication of silver nanoparticles being synthesized can be change in the color of the solution to yellowish-brown after 30 minutes of Ultrasonication. The solution can thereafter be subjected to microwave irradiations, at step 130. After the predetermined duration, the produced silver nanoparticles can be separated from the solution, at step 140. The nanoparticles can be washed, at step 150, and then freeze dried, at step 160.

### EXAMPLES

The present invention is further exemplified, but not limited, by the following and Examples that illustrate the preparation of the compounds of the invention.

### Example 1

Materials: Carboxymethyl cellulose salt (Sigma Aldrich-C5013), silver nitrate solution (Merck-CAS 7761-88-8/0.001M), Acetone (Merck-CAS 67-64-1) for the chemical section and Plate Count Agar (PCA) culture media (Merck-105463), Escherichia coli (lyophilized, ATCC:25922, Iranian Biological Resource Center), Staphylococcus aureus (lyophilized, ATCC:29213, Iranian Biological Resource Center), Brain Heart Infusion Broth (BHI) culture media (Merck-110493) for microbial section.

Devices: Ultrasonic (FAPAN 400UF), oven microwave, centrifuge (Hettich-MIKRO 22R), freeze dryer, UV-Vis spectrophotometry (Perkin Elmer-Lambda 2), Transmission Electron Microscopy (TEM) (Philips-CM120), FTIR spectroscopy (Nicolet-Nexus 870). As for the microbial analysis of synthesized silver nanoparticles, the obtained devices were vortex, spectrophotometry, autoclave, and incubator.

### (a) Silver Nanoparticles Synthesis

Carboxymethyl cellulose solution (CMC) was prepared by adding CMC in water in a concentration of 1%. Subsequently, 100 ml of silver nitrate solution (0.001M) was added to CMC 1% solution drop by drop while mixing at room temperature with 1500 rpm via ultrasonic. After 30 minutes, the resultant solution was placed in an oven microwave with the power of 400 watts for 6 hours. After 6 hours, the produced silver nanoparticles were separated from the rest of the solution using a high-speed centrifuge, and then the silver nanoparticles were washed with acetone three to four times. Thereafter, the silver nanoparticles were thoroughly dried after being placed in a freeze dryer for 48 hours.

### (b) Silver Nanoparticles Characterization

### (b.1) UV-Visible Spectrophotometry

UV-visible spectrophotometry was used to analyze the silver nanoparticles (diffraction width of 1 nm and absorption speed of 400 nm/min in comparison with distilled water as control sample). In all records of UV-Vis spectra, 0.01 gr of colloidal suspension from each sample combined with 25 ml water were placed in ultrasonic to disperse in water finely. Then the samples were transferred to UV-vis cuvettes to analyze the rate of absorption via SNPs.

### (b.2) Transmission Electron Microscopy (TEM)

Silver nanoparticles morphology and size analysis were performed using TEM. One drop of the sample was placed on a surface covered with Carbon or Copper and dried at room temperature, and then it was inserted to the TEM device for analysis.

### (b.3) FTIR Spectroscopy

FTIR spectroscopy was used for recognition and stratification of biomolecules involved in Silver nanoparticles structure, which could be a capping or stabilizing agent. For this characterization, the device was calibrated using potassium bromide (KBr), then the silver nanoparticles were placed to the device as a powder for further analysis,

### Results:

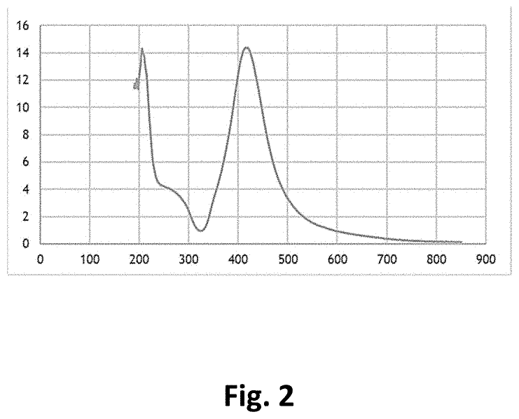

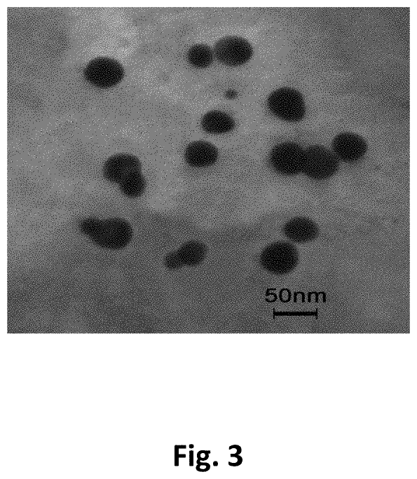

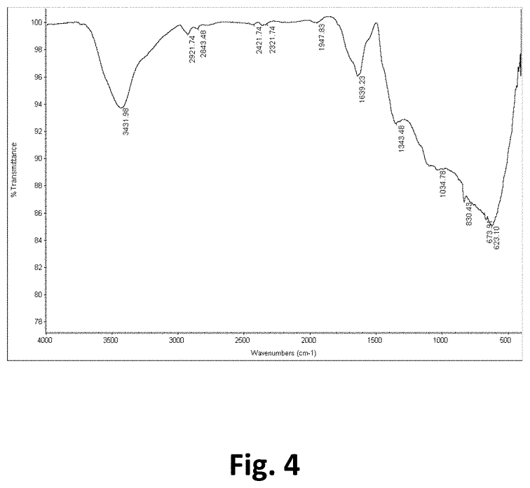

UV-Vis Graph of the produced silver nanoparticles is depicted in FIG. 2, which indicates that maximum absorbance occurred in 420 nm. According to picture 1 obtained from Sigma Aldrich, the size of nanoparticles was in the range of 30-40 nm Transmission Electron Microscopy image shown in FIG. 3 shows that the estimated particle size was around 50 nm with an appropriate distribution of nanoparticles. To be specific, there was no agglomeration or coagulation found in the TEM image of synthesized silver nanoparticles. FIG. 4 depicts the FTIR spectrum, which was recorded in the range from 500 to 4000 cm⁻¹ for recognition of the possible bio-molecules present in CMC. The bands at 3423.16, 2364.49, 1626.02, 1025.81, 813.89 cm⁻¹ was due to O—H, N—H, C═C, S═O, C═C bending respectively, which indicates the existence of alcohol, amines, ketones, sulfoxides, and alkene in CMC composition. Thus, showing that the biomolecules were present in the synthesis of silver nanoparticles.

### (c) Minimum Bactericidal Concentration (MBC)

Antimicrobial activity of the produced Silver nanoparticles was evaluated for MIC and MBC. After analyzing the tubes for MIC, the first tube in each column that was contained, bacterial growth was evaluated as MIC. Then from the mentioned tube and the two tubes before the MIC tube there would be sampling using a sterilized loop, and the samples were cultured in plates containing agar. The plates were incubated for 24 hours and evaluated for bacterial growth at the end.

### (a) MIC Test

After 24 hours of incubation, the synthesized silver nanoparticles had more inhibition effects on E. coli rather than Staphylococcus aureus. Based on further observations, the minimum inhibitory concentration of silver nanoparticles was 12.34 μg/ml on E. coli, While the minimum concentration of synthesized silver nanoparticles needed for inhibition of E. coli growth was 1.37 μg/ml

### (b) MBC Test

In compliance with MIC results, minimum bactericidal concentrations of silver nanoparticles were evaluated by culturing tubes without any bacterial growth on an agar plate, which was tubes 1,2,3 containing Staphylococcus aureus and cells 4,5,6 containing E. coli. After the incubation of the plate, there was no bactericidal effect of silver nanoparticles found on Staphylococcus aureus since all sections containing this bacteria showed bacterial growth. The minimum concentration of silver nanoparticles with the bactericidal effect needed for E. coli was 4.115 μg/ml.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for production of silver nanoparticles, the method comprising:
dropwise adding a silver nitrate solution to a carboxy methyl cellulose solution while stirring the resultant solution;
subjecting the resultant solution to ultrasonic irradiation for a first predetermined duration;
upon ultrasonication, subjecting the solution to microwave irradiation [temperature?] for a second predetermined duration;
separating produced silver nanoparticles from the solution;
washing the silver nanoparticles; and
freeze drying the silver nano particles.

2. The method of claim 1, wherein the carboxy methyl cellulose solution is prepared by mixing carboxy methyl cellulose powder in water.

3. The method of claim 2, wherein the carboxy methyl cellulose solution is prepared in a concentration of 1%, the silver nitrate solution is having a concentration of 0.001 M and 100 ml of the silver nitrate solution is added to the carboxy methyl cellulose solution.

4. The method of claim 1, wherein the first predetermined duration is 30 minutes.

5. The method of claim 1, wherein the second predetermined duration is 6 h.

6. The method of claim 1, wherein the silver nanoparticles are separated using centrifugation.
